(19) United States
(12) Patent Application Publication
(10) Pub. No.: US 2010/0042544 A1
(43) Pub. Date: Feb. 18, 2010

(54) Process for creating a multimedia interactive book

(76) Inventors: Charles Craig Breaux, Oakland, CA (US); Ramkum Ar Srinivasan, Union City, CA (US); Michael Noel Payne, Alameda, CA (US); Brian Keith Dickerson, Concord, CA (US)

Correspondence Address: Payne Breaux Group, LLC, 8453 Vast Horizon Avenue, Las Vegas, NV, 89129, US

(21) Appl. No.: 12/228,920

(22) Filed: Aug. 18, 2008

(51) Int. Cl. H04L 9/00; G09B 3/00

(52) U.S. Cl. 705/59; 434/350

(57) ABSTRACT

A method for an educator to teach a subject with of: a system which allows a plurality of computer users a of accessing a secured, interactive, multimedia, animated knowledge base created by expert(s), the system identifies and differentiates: administrators, educators, students, advertisers and browsers, allowing each predetermined access, where access is a defined characteristics of the system, characteristics of the system includes: predetermined access, predetermined access timeframes, predetermined roles of the system, the knowledgebase is comprised of: information being proven and well-accepted by experts knowledgeable in the subject,

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Insert Description of Attached Appendix here.

### BACKGROUND OF THE INVENTION

Classrooms have remained virtually unchanged for nearly a hundred years—teachers wrote on chalkboards at the front of the room and students read from printed textbooks. With the advent of whiteboards, projection equipment and individual computers, things have changed.

The present invention is generally directed to a method and system of content management developed in a manner to provide the user remote access over a communication link or CD based access. Electronic text books are a broad term that generally refers to having the books writing a computer format. Electronic text books are accessed with the use of desktop or laptop computers as well as handheld devices such as personal digital assistants (PDAs). In the education environment, a trend is developing to allow readers to access text information electronically. With the addition of electronic books we can now give readers animated examples to help with the understanding of the material. The saying a picture is worth a thousand words, then 12 frames per second is worth millions. Some examples allow the student to change the value to see different results and others allow the student to enter his/her answer and verify the answer.

Several systems provide electronic books (e-books), for example U.S. Pat. No. 5,535,888 to Lebby et al., U.S. Pat. No. 5,761,485 to Munyan, and U.S. Pat. No. 5,956,034 to Sachs et al. However, none of these patents disclose communication between teacher and students pursuing a course of study.

Patents which describe linking multimedia supplementary material, link the material to print text, not electronic text and do not disclose a teacher-student environment with bi-directional communication. For example U.S. Pat. No. 5,954,515 to Igguiden describes a method for augmenting a print text by providing graphical indicia at points in the text indicating that supplementary materials from a host computer are available for download. However, neither a teaching environment nor means for communicating with an instructor are disclosed. Likewise, U.S. Pat. No. 5,645,432 to Jessop discloses linking audiovisual material to print text aligned with pressure sensing means, when the user presses portions of the print material. These supplementary materials must be inserted into the device and are not located on a remote computer.

A patent describes linking the teacher and student communication and the use of a teacher assistant function, for example U.S. Pat. No. 6,549,751 to Mandri. However, this patent does not reference a knowledge base provided to the institution, teachers and students. Our system will allow students and teachers to access the knowledge base using a computer with disc or internet accessibility.

With affordable network computers and access to the internet and World Wide Web, it is now possible for students and educators to communicate over large areas. The invention of the web browser and flash programming language allows our knowledge base to combine text with animation and video. Our knowledge base with its meticulously constructed animated and interactive examples of real world problems bridges the gap between static text and the reader's ability to visualize problems. Our knowledge base also allows the student to change to parameters in the examples to illustrate different real life situations.

### BRIEF SUMMARY OF THE INVENTION

Other objects and advantages of the present invention will become apparent from the following descriptions, taken in connection with the accompanying drawings, wherein, by way of illustration and example, an embodiment of the present invention is disclosed.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A method for an educator to teach a subject comprising of: a system which allows a plurality of computer users a means of accessing a secured, interactive, multimedia, animated knowledge base created by expert(s); the said system identifies and differentiates: administrators, educators, students, advertisers and browsers;
allowing each predetermined access, where access is a defined characteristics of the system; characteristics of the system includes: predetermined access; predetermined access timeframes; predetermined roles of the system; said knowledgebase is comprised of: information being proven and well-accepted by experts knowledgeable in the subject;

2. A method for an institution, an educator and a student to teach or learn a subject comprising of a system which allows a plurality of computer users to access our knowledge base.

3. The said system, see claim 1 identifies and differentiates administrators, educators, students and advertisers access to defined areas of the system.

4. The system identifies users of class administrations, administrators can assign educators and students to license use of our knowledge base in a specified time frame.

5. A student identified by the system is allowed specified access; the system identifies the student and connects the student to the predetermined subset of the knowledge base.

6. A general browser accessing the system can purchase an agreement license to use our knowledge base in a specified time frame.

7. The knowledge base is independent of the system.

8. The knowledge base of claim 1 can only be modified the knowledge base creators.

9. A method of providing animated multimedia content of knowledge base to an institution, an educator or a student.

10. The system allows administrators to assign educators and students access to our knowledge base.

11. The system of claim 1 allows administrators to send messages to educators and students.

12. The system of claim 1 allows educators to send messages to administrators and students.

13. The system of claim 1 allows students to send messages to administrators and educators.

14. The system allows institutions and other users to purchase licenses or time shared access to the knowledge base.

15. An interactive problem allows a student to solve the problem and enter the solution. The problem will respond with a correct or incorrect answer.

16. A system wherein the users movements are tracked and stored allowing the student to return to book marked pages, or the last page read on the last login into the system.

17. A system that restricts access to the web site by license users of the system or methods.
